(19) United States
(12) Patent Application Publication
(10) Pub. No.: US 2023/0289640 A1
(43) Pub. Date: Sep. 14, 2023

(54) QUANTUM CIRCUIT SIMULATION

(71) Applicant: Tencent Technology (Shenzhen) Company Limited, Shenzhen (CN)

(72) Inventors: Shixin ZHANG, Shenzhen (CN); Zhouquan WAN, Shenzhen (CN); Shengyu ZHANG, Shenzhen (CN)

(73) Assignee: Tencent Technology (Shenzhen) Company Limited, Shenzhen (CN)

(21) Appl. No.: 18/199,699

(22) Filed: May 19, 2023

Related U.S. Application Data
(63) Continuation of application No. PCT/CN2022/133406, filed on Nov. 22, 2022.

(30) Foreign Application Priority Data
Jan. 24, 2022 (CN) 202210077584.7

(51) Int. Cl. G06N 10/20

(52) U.S. Cl. CPC G06N 10/20

(57) ABSTRACT

A method of a quantum circuit simulation includes receiving a primitive function for the quantum circuit simulation, and determining at least a first input parameter of the primitive function. The quantum circuit simulation includes a plurality of first tensors respectively for the first input parameter. The method includes converting the primitive function to a target function according to the primitive function and the at least the first input parameter. The target function includes a converted first input parameter corresponding to the first input parameter, the plurality of first tensors are spliced into a second tensor for the converted first input parameter in the quantum circuit simulation. The method further includes obtaining an execution result of the target function according to at least the second tensor for the converted first input parameter, and performing the quantum circuit simulation based on the execution result of the target function.

### RELATED APPLICATIONS

The present application is a continuation of International Application No. PCT/CN2022/133406, filed on Nov. 22, 2022 and entitled “QUANTUM CIRCUIT SIMULATION METHOD AND APPARATUS, DEVICE, STORAGE MEDIUM, AND PROGRAM PRODUCT,” which claims priority to Chinese Patent Application No. 202210077584.7, filed on Jan. 24, 2022 and entitled “QUANTUM CIRCUIT SIMULATION METHOD AND APPARATUS, DEVICE, STORAGE MEDIUM, AND PROGRAM PRODUCT.” The entire disclosures of the prior applications are hereby incorporated by reference in their entirety.

### FIELD OF THE TECHNOLOGY

Embodiments of this disclosure relate to the field of quantum technologies, including a quantum circuit simulation method and apparatus, a device, a storage medium, and a program product.

### BACKGROUND OF THE DISCLOSURE

Quantum circuit simulation includes simulating and approximating the behavior of a quantum computer through a classical computer and numerical computation.

Currently, the efficiency of quantum circuit simulation is not high.

### SUMMARY

Embodiments of this disclosure provide a quantum circuit simulation method and apparatus, a device, a storage medium (e.g., non-transitory computer readable storage medium), and a program product.

Some aspects of the disclosure provide a method of a quantum circuit simulation. The method includes receiving a primitive function for the quantum circuit simulation and determining at least a first input parameter of the primitive function. The quantum circuit simulation includes a plurality of first tensors respectively for the first input parameter. The method includes converting the primitive function to a target function according to the primitive function and the at least the first input parameter. The target function includes a converted first input parameter corresponding to the first input parameter, the plurality of first tensors are spliced into a second tensor for the converted first input parameter in the quantum circuit simulation. The method further includes obtaining an execution result of the target function according to at least the second tensor for the converted first input parameter, and performing the quantum circuit simulation based on the execution result of the target function.

Some aspects of the disclosure provide an apparatus for a quantum circuit simulation. The apparatus includes processing circuitry configured to receive a primitive function for the quantum circuit simulation and determine at least a first input parameter of the primitive function. The quantum circuit simulation includes a plurality of first tensors respectively for the first input parameter. The processing circuitry is configured to convert the primitive function to a target function according to the primitive function and the at least the first input parameter. The target function includes a converted first input parameter corresponding to the first input parameter, and the plurality of first tensors are spliced into a second tensor for the converted first input parameter in the quantum circuit simulation. The processing circuitry is further configured to obtain an execution result of the target function according to at least the second tensor for the converted first input parameter and perform the quantum circuit simulation based on the execution result of the target function.

Some aspects of the disclosure provide a non-transitory computer-readable storage medium storing instructions which when executed by at least one processor cause the at least one processor to perform the method of the quantum circuit simulation.

The technical solutions provided in the embodiments of this disclosure may bring the various beneficial effects. The idea of vector parallelism is introduced into the quantum circuit simulation. The primitive function is converted to the target function, the input parameter of the target function including the converted first input parameter corresponding to the first input parameter that needs to be parallelized, and the tensor corresponding to the converted first input parameter being the result obtained by splicing the plurality of parallelized tensors corresponding to the first input parameter. By executing the target function, a plurality of original computing processes can be parallelized into a single computing process, which can be completed in the same time as the single computation, thereby fully improving the efficiency of quantum circuit simulation.

### BRIEF DESCRIPTION OF THE DRAWINGS

FIG. 1 is a flowchart of a quantum circuit simulation method according to an embodiment of this disclosure.

FIG. 2 is a functional schematic diagram of the vmap interface according to an embodiment of this disclosure.

FIG. 3 is a flowchart of a quantum circuit simulation method according to another embodiment of this disclosure.

FIG. 4 is a schematic diagram of numerical simulation of a target quantum circuit according to an embodiment of this disclosure.

FIG. 5 is a schematic diagram of parallelized processing of an input wave function according to an embodiment of this disclosure.

FIG. 6 is a schematic diagram of parallelized optimization of a circuit variation parameter according to an embodiment of this disclosure.

FIG. 7 is a schematic diagram of a tensor network including parameterized structural information according to an embodiment of this disclosure.

FIG. 8 is a schematic diagram of parallelized generation of a circuit structure according to an embodiment of this disclosure.

FIG. 9 is a schematic diagram of an experimental result according to an embodiment of this disclosure.

FIG. 10 is a block diagram of a quantum circuit simulation apparatus according to an embodiment of this disclosure.

FIG. 11 is a schematic diagram of a computer device according to an embodiment of this disclosure.

### DESCRIPTION OF EMBODIMENTS

In order to make objectives, technical solutions, and advantages of this disclosure clearer, implementations of this disclosure are further described in detail below with reference to the drawings.

Before description of the technical solutions of this disclosure, some key terms in this disclosure are explained.

1. Quantum computing is, for example, a basic unit for data storage based on a quantum logic computing way such as a qubit (or quantum bit).

2. Qubit is, for example, a basic unit of quantum computing. Conventional computers use 0s and 1s as basic units of binary, while quantum computing can process 0s and 1s simultaneously, and quantum computing systems may be in a linear superposition state of 0s and 1s, that is: |ψ [symbol] =α|0 [symbol] +β|1 [symbol] . α, β represent complex probability amplitudes of the system on 0 and 1. Their modular squares |α|², |β|² respectively represent probabilities of being at 0 and 1.

3. Quantum circuit is, for example, a representation of a quantum general purpose computer, which represents a hardware implementation of a corresponding quantum algorithm/program in a quantum gate model. If the quantum circuit includes an adjustable parameter for controlling a quantum gate, the quantum circuit is referred to as a parameterized quantum circuit (PQC) or a variational quantum circuit (VQC), which are the same concept.

4. Hamiltonian is, for example, a Hermitian matrix describing the total energy of a quantum system. Hamiltonian is a physical term that describes the total energy of a system, which is usually represented by H.

5. Eigenstate for the Hamiltonian matrix H in an example, includes a solution satisfying the equation H|ψ=E|ψ [symbol] which can be referred to as an eigenstate |ψ [symbol] of H, which has the eigenenergy E. The ground state corresponds to a lowest energy eigenstate of the quantum system.

6. Classical quantum hybrid computing is, for example, a computing paradigm in which a quantum circuit (such as the PQC) is used in an inner layer to compute a corresponding physical quantity or a loss function and a conventional classical optimizer is used in an outer layer to adjust a variational parameter of the quantum circuit, which can maximize the advantages of the quantum computing and is believed to be one of the significant directions with potential to prove the advantages of quantum. The paradigm of the classical quantum hybrid computing can also be referred to as a variational quantum algorithm.

7. Noisy intermediate-scale quantum (NISQ): Recently, medium-scale quantum hardware with noise is the current stage and research focus of development of the quantum computing. In this stage, the quantum computing temporarily cannot be used as a general-purpose computing engine due to limitations such as the scale and noise. However, in some aspects, the quantum computing can achieve results that surpass those of the strongest classical computer, which is usually referred to as quantum hegemony or quantum advantage.

8. Variational quantum eigensolver (VQE for short) is, for example, a typical classical quantum hybrid computing paradigm that estimates the ground state energy of a specific quantum system through a variational circuit (PQC/VQC), which is widely used in the field of quantum chemistry.

9. Pauli string is, for example. a term formed by a direct product of a plurality of Pauli matrices at different lattice points. A general Hamiltonian usually may be decomposed into a sum of a group of Pauli strings. Measurements by a VQE are generally performed term by term by partitioning Pauli strings. An expected value of each Pauli string may be estimated by averaging a plurality of measurements on the quantum circuit.

10. Bitstring (also referred to as classic bitstring) is, for example, a string of numbers formed by 0 and 1. Each classical result measured by a quantum circuit may be represented by a 0 and a 1 for spin up and spin down respectively in a measurement-based spin configuration, and thus an overall measurement result corresponds to a bit string. A measured value of each measurement of the Pauli string is provided by bitstring computation.

11. Quantum circuit software simulation includes, for example, simulating and approximating the behavior of a quantum computer through a conventional computer and numerical computation. The quantum circuit software simulation may be referred to as “quantum circuit simulation” for short.

12. Vector parallelism may be implemented by performing hardware-supported vectorization on all operators of a primitive function one by one, so as to implement high-speed parallelism of high-level functions. This implementation is usually performed together with static graph compiling. For example, for a function f(x)=2xx, when 1 is inputted, 2 is returned, that is, f(1)=2. In a vector parallelism version fv(x), fv([1, 2])=[2, 4] may be implemented. This process does not require successive computing. Instead, a vector instruction set (or referred to as a vectorized instruction set) on the hardware may be used to complete the computations at one time. Therefore, the computing time of fv([1,2]) is almost the same as that of f (1), which is half less than that spent for computing f(1) and f(2) successively. If a size of a vector dimension (a parallelism dimension/batch dimension) further increases, the acceleration is more prominent. In this example, f(x) is the primitive function, and the multiplication is the unique operator that appears. Vectorization support for the computation depends on the hardware, such as a vector instruction set on a central processing unit (CPU) or a graphics processing unit (GPU). f herein is a high-level function. An interface encapsulated in a modern machine learning framework may be used to implement vector parallelism without a need to consider hardware details and the underlying implementation off. The static map compiling is a process provided by the modern machine learning framework to compile and fuse application programming interfaces (APIs) for high-level computing into underlying hardware operations, which can accelerate numerical computations.

13. Pauli operators, also referred to as Pauli matrices, may refer to a set of three 2×2 complex unitary Hermitian matrices (also referred to as unitary matrices), and are usually represented by the Greek alphabet σ (Sigma). A Pauli operator X is

$${σ}_{x} = [ \begin{matrix}0 & 1 \\ 1 & 0\end{matrix} ] ,$$

a Pauli operator Y is

$${σ}_{y} = [ \begin{matrix}0 & - i \\ i & 0\end{matrix} ] ,$$

and a Pauli operator Z is

$${σ}_{z} = [ \begin{matrix}1 & 0 \\ 0 & - 1\end{matrix} ] .$$

14. Differentiable architecture search (DARTS for short) is, for example, a popular neural architecture search (NAS) solution that implements end-to-end differential computation and gradient descent search in a super network by allowing a plurality of operation layers between different nodes to be weighted and added together, so that the searching speed of the neural network structure is greatly improved. The DARTS does not search for discrete candidate structures, but instead makes the search space continuous, which can optimize the network structure based on the performance of a validation set through gradient descent. The gradient based optimization algorithm allows DARTS to compete with the current top-notch performance and reduce computation by a plurality of orders of magnitude compared to inefficient black box search.

15. Quantum architecture search (QAS for short) is, for example, a general name of a series of works and solutions used for attempting to perform automatic and programmed search for the structure, mode, and layout of a quantum circuit. Conventionally, a greedy algorithm, reinforcement learning, or a genetic algorithm is usually used as the core technology of quantum structure search. The new differentiable quantum structure search technology can iteratively evaluate the advantages and disadvantages of quantum circuit structures in batches with high throughput.

16. Tensor network includes, for example, a series of tensors and connection information between the tensors, which can represent high-dimensional tensors with less information. Each quantum circuit may be mapped into a tensor network. Therefore, the quantum circuit may be simulated by the way of the contraction of the tensor network.

In the application scenario of quantum circuit simulation, for some dimensions that need to be parallelized, a simple serial loop computation is usually performed, that is, a simple for loop is performed to implement the corresponding a plurality of computations. In this case, the parallelism is 0. Therefore, if a size of the to-be-parallelized dimension is 1000, 1000 times the time for the single computation is required to implement software simulation.

A bit of more optimized solution is to accelerate processing of to-be-parallelized computing parts by using a multiprocessing or multithreading technology. This solution allows different computations that need a parallelism dimension to be distributed over different processes for simultaneous processing. However, the solution is usually limited by hardware architectures and operating systems, and needs to be implemented separately for different hardware. The reason is that a high-level program interface implemented through multiprocessing or multithreading significantly relies on hardware details and operating systems, and therefore requires rewriting of code when run on different software and hardware, resulting in low code reusability. This increases the development and usage costs by a large amount, and the support for multiprocessing and multithreading on heterogeneous hardware such as a GPU and a tensor processing unit (TPU) is not user-friendly. In a multiprocessing case, each task is computed only on a single process, so a vector operation set (that is, hardware's intrinsic vector operation set support) is underutilized. In addition, the multiprocessing parallelism is limited by a number of CPU cores, and a single CPU may usually run only several or dozens of computing modules simultaneously. For a to-be-parallelized dimension of 1000, a time several tens of times or more time is required to complete the single computation.

This disclosure proposes to introduce the idea of vector parallelism into the quantum circuit simulation. In essence, in the vector parallelism in this disclosure, a parallel dimension is considered as an additional dimension of linear algebra, and a batch parallelism capability is directly implemented from the underlying operator, which can give full play to the advantages of hardware such as a GPU. For example, for a parallel dimension size of 1000, the same time as the single computation is usually required. Therefore, the efficiency of large-scale quantum simulations is much higher than that of previous solutions. In addition, the solution has a desirable design interface and is independent of backend hardware and system details, which is extremely convenient for use and development.

Steps in a quantum circuit simulation method provided in the embodiments of the disclosure may be performed by a classic computer, such as a personal computer (PC). For example, the method is implemented by executing a corresponding computer program through the classic computer. In the following method embodiments, for ease of explanation, the steps are performed by a computer device, for example.

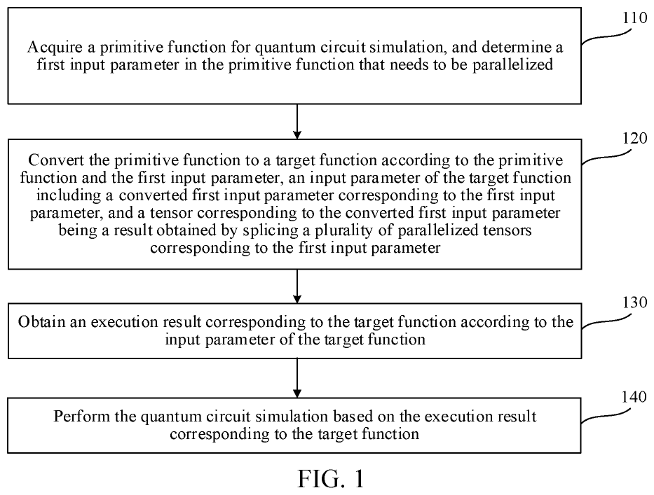

FIG. 1 is a flowchart of a quantum circuit simulation method according to an embodiment of this disclosure. Steps of the method may be performed by a computer device, such as a classical computer. The method may include the following steps (110-140):

In step 110, a primitive function for quantum circuit simulation is acquired, and a first input parameter in the primitive function that needs to be parallelized is determined.

A process of the quantum circuit simulation may include one or more of steps such as processing an input wave function, optimizing a circuit variation parameter, generating circuit noise, generating a circuit structure, and performing circuit measurement. In some embodiments, the primitive function is configured to implement a target step in the quantum circuit simulation. The target step includes but is not limited to any one of processing an input wave function, optimizing a circuit variation parameter, generating circuit noise, generating a circuit structure, and performing circuit measurement. For example, the primitive function is configured to process an input wave function. The primitive function is configured to compute an input wave function of a target quantum circuit to obtain a corresponding computing result. For example, the primitive function is configured to optimize the circuit variation parameter. The primitive function is configured to optimize a circuit variation parameter of the target quantum circuit, to obtain an optimized circuit variation parameter.

The primitive function may have one or more input parameters. The above first input parameter is the input parameter in the primitive function that needs to be parallelized. There may be one or more first input parameters. For example, the primitive function f is denoted as f (x, y, w), which indicates that the primitive function f has three input parameters, including x, y, and w. It is assumed that x in the three input parameters of the primitive function f needs to be parallelized. In this case, the above first input parameter is x, and the other two parameters y and w do not need to be parallelized. Alternatively, it is assumed that x and y in the three input parameters of the primitive function f need to be parallelized. In this case, the above first input parameter is x and y, and the other one parameter w does not need to be parallelized.

A different primitive function may have a different input parameter, and therefore has a different first input parameter that needs to be parallelized. In actual application, after the primitive function is determined, the input parameter is determined. One or more input parameters suitable for parallelism may be selected as the first input parameter according to an actual situation.

In step 120, the primitive function is converted to a target function according to the primitive function and the first input parameter, an input parameter of the target function includes a converted first input parameter corresponding to the first input parameter, and a tensor corresponding to the converted first input parameter is a result obtained by splicing a plurality of parallelized tensors corresponding to the first input parameter;

The input parameter of the target function includes the converted first input parameter corresponding to the first input parameter that needs to be parallelized. In some embodiments, if the input parameter of the primitive function further includes a target input parameter that does not need to be parallelized in addition to the first input parameter that needs to be parallelized, the target function may be obtained in the following way: modifying the first input parameter in the primitive function to the converted first input parameter and retaining the target input parameter that does not need to be parallelized, to obtain the target function. That is to say, the input parameter of the target function not only includes the converted first input parameter corresponding to the first input parameter, but also includes the target input parameter that does not need to be parallelized. Exemplarily, the primitive function f is denoted as f (x, y, w). It is assumed that x and y in the three input parameters of the primitive function f need to be parallelized and w does not need to be parallelized. In this case, a target function f′ may be denoted as f′ (xs, ys, w). xs represents converted x corresponding to the input parameter x, ys represents converted y corresponding to the input parameter y, and the input parameter w is not converted since it does not need to be parallelized.

In some embodiments, if the input parameter of the primitive function does not include the target input parameter that does not need to be parallelized, the target function may be obtained in the following way: modifying the first input parameter in the primitive function to the converted first input parameter, to obtain the target function. Exemplarily, the primitive function f is denoted as f (x, y, w). It is assumed that the three input parameters of the primitive function f all need to be parallelized. In this case, a target function f′ may be denoted as f′ (xs, ys, ws). xs represents converted x corresponding to the input parameter x, ys represents converted y corresponding to the input parameter y, and ws represents converted w corresponding to the input parameter w.

In some embodiments, if a parallelism size (also referred to as a “batch size”) corresponding to the first input parameter is n, n being an integer greater than 1, it means that n tensors corresponding to the first input parameter are parallelized. In this case, the tensor corresponding to the converted first input parameter is an integration result (or a “splicing result”) of the n tensors. In this embodiment of this disclosure, the tensor is a high-dimensional array including n₁×n₂×n₂ . . . ×nₘ numbers, m being an order of the tensor, m being a positive integer. When m=1, the tensor is a one-dimensional array, that is, a vector. When m=2, the tensor is a two-dimensional array, that is, a matrix. Certainly, m may alternatively be an integer of 3 or greater than 3, that is, the dimension number of the tensor array may be infinitely expanded.

In some embodiments, a plurality of parallelized tensors corresponding to the first input parameter are spliced in a target dimension to obtain the tensor corresponding to the converted first input parameter, a size of the tensor corresponding to the converted first input parameter in the target dimension corresponds to a number of the parallelized tensors corresponding to the first input parameter.

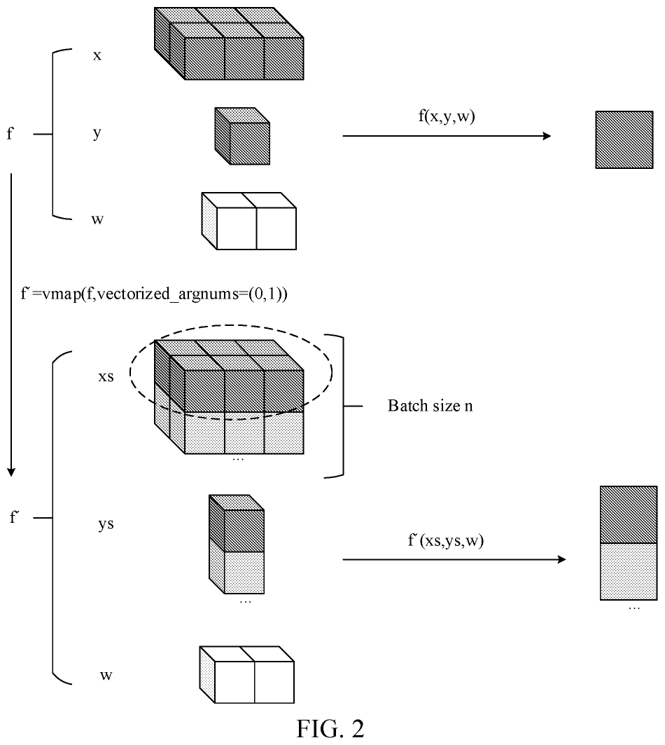

Exemplarily, as shown in FIG. 2, for the input parameter x in the primitive function f (x, y, w) that needs to be parallelized, it is assumed that a corresponding parallelism size thereof is n. In this case, the n tensors corresponding to the input parameter x are spliced in the target dimension, and a tensor obtained by the splicing is a tensor corresponding to xs. In some embodiments, a value of n may be 2, 10, 50, 100, 200, 500, 1000, or the like, which may be set according to an actual need. This is not limited in this disclosure.

In step 130, an execution result corresponding to the target function is obtained according to the input parameter of the target function.

After the primitive function is converted to the target function, the target function is executed to obtain the corresponding execution result. In some embodiments, the target function is executed through vector parallelism to obtain the execution result corresponding to the target function. The converted first input parameter included in the input parameter of the target function is processed through vector parallelism, to obtain the execution result corresponding to the target function. In some embodiments of this disclosure, the idea of vector parallelism is introduced into the quantum circuit simulation. Since the input parameter of the target function includes the converted first input parameter, the tensor corresponding to the converted first input parameter may be processed through vector parallelism, so that the execution result corresponding to the target function which can be computed directly through one step.

It is assumed that an execution time of the primitive function is t, and the parallelism size is n. If the primitive function is executed n times through simple loop, the required total time is n×t. After the primitive function is converted to the target function, a time required to execute the target function through vector parallelism is theoretically t, which is greatly reduced compared to n×t. In addition, as n increases, the reduction will become more prominent.

In step 140, the quantum circuit simulation is performed based on the execution result corresponding to the target function.

After the execution result corresponding to the target function is obtained, the quantum circuit simulation may be performed. For example, the primitive function is configured to process the input wave function. Correspondingly, the execution result corresponding to the target function includes processing results respectively corresponding to a plurality of input wave functions. Subsequently, steps such as optimizing the circuit variation parameter may be performed based on the processing results respectively corresponding to the plurality of input wave function. For example, the primitive function is configured to optimize the circuit variation parameter. Correspondingly, the execution result corresponding to the target function includes optimization results respectively corresponding to a plurality of groups of circuit variation parameters. Subsequently, an optimal group of circuit variation parameters may be selected as a final target quantum circuit based on the optimization results respectively corresponding to the plurality of groups of circuit variation parameters.

In addition, the behavior of simulating and approximating the quantum computer (or the quantum circuit) through the classical computer and numerical computation is implemented through the quantum circuit simulation, which accelerates the research and design of the quantum circuit and reduce the costs.

In the technical solution of this disclosure, the idea of vector parallelism is introduced into the quantum circuit simulation. The primitive function is converted to the target function, the input parameter of the target function including the converted first input parameter corresponding to the first input parameter that needs to be parallelized, and the tensor corresponding to the converted first input parameter being the result obtained by splicing the plurality of parallelized tensors corresponding to the first input parameter. By executing the target function, a plurality of original computing processes can be parallelized into a single computing process, which can be completed in the same time as the single computation, thereby fully improving the efficiency of quantum circuit simulation.

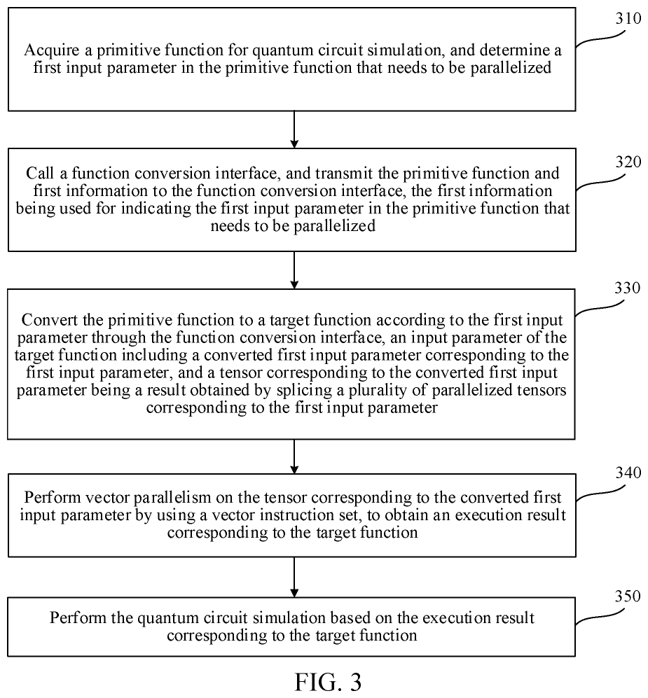

FIG. 3 is a flowchart of a quantum circuit simulation method according to another embodiment of this disclosure. Steps of the method may be performed by a computer device, such as a classical computer. The method may include the following steps (310-350):

In step 310, a primitive function for quantum circuit simulation is acquired, and a first input parameter in the primitive function that needs to be parallelized is determined.

Step 310 may be the same as step 110 in the embodiment shown in FIG. 1. For an exemplary implementation, reference may be made to the description in the embodiment shown in FIG. 1.

In step 320, a function conversion interface is called, and the primitive function and first information are transmitted (provided) to the function conversion interface, the first information is used for indicating the first input parameter in the primitive function that needs to be parallelized.

The function conversion interface is configured to implement the function of converting the primitive function into the target function. The function conversion interface may be a user-oriented interface, such as an API.

The first information is used for indicating the first input parameter in the primitive function that needs to be parallelized. In some embodiments, the first information is used for indicating a location of the first input parameter in the primitive function that needs to be parallelized. For example, in the primitive function f (x, y, w), location numbers of the input parameters x, y, and w are 0, 1, and 2 respectively. If it is assumed that the input parameter that needs to be parallelized is x, the first information is 0. Alternatively, if it is assumed that the input parameter that needs to be parallelized includes x and y, the first information includes 0 and 1. By indicating the first input parameter in the primitive function that needs to be parallelized through locations, accurate and concise indication can be implemented.

In step 330, the primitive function is converted to the target function according to the first information through the function conversion interface, an input parameter of the target function includes a converted first input parameter corresponding to the first input parameter, and a tensor corresponding to the converted first input parameter is a result obtained by splicing a plurality of parallelized tensors corresponding to the first input parameter;

The function conversion interface determines, according to the first information, the first input parameter in the primitive function that needs to be parallelized, and then converts the primitive function to the target function based on the first input parameter. For example, for the first input parameter in the primitive function that needs to be parallelized, a plurality of parallelized tensors corresponding to the first input parameter are spliced in the target dimension, to obtain the tensor corresponding to the converted first input parameter. For the target input parameter in the primitive function that does not need to be parallelized, the target input parameter is directly retained as the input parameter of the target function. Therefore, the input parameter of the target function includes the converted first input parameter, and optionally, further includes the target input parameter. The function conversion interface supports the vector parallelism function. After the above conversion of the function conversion interface, the target function may be used to output a result of a plurality of parallel computations of the primitive function.

In some embodiments, the function conversion interface not only supports the vector parallelism function, but also supports an automatic differentiation function, so that the target function converted by the function conversion interface is not only configured to output the result obtained by the plurality of parallel computations of the primitive function, but also to output derivative information of the primitive function relative to a second input parameter. The second input parameter is an input parameter of the input parameters of the primitive function for which a derivative is to be calculated. There may be one or more second input parameters. In addition, the second input parameter may be the same as or different from the first input parameter. For example, in the primitive function f (x, y, w), the input parameter includes x, y, and w, the first input parameter that needs to be parallelized is x, and the second input parameter for which a derivative is to be calculated is also x. Alternatively, the first input parameter that needs to be parallelized includes x and y, and the second input parameter for which a derivative is to be calculated is x. Alternatively, the first input parameter that needs to be parallelized is x, and the second input parameter for which a derivative is to be calculated is y, and so on.

In some embodiments, during the calling of the function conversion interface, the primitive function, the first information, and second information are transmitted to the function conversion interface. The second information is used for indicating the second input parameter in the primitive function for which a derivative is to be calculated. In some embodiments, the second information is used for indicating a location of the second input parameter in the primitive function for which a derivative is to be calculated. For example, in the primitive function f (x, y, w), location numbers of the input parameters x, y, and w are 0, 1, and 2 respectively. If it is assumed that the first input parameter that needs to be parallelized includes x and y, and the second input parameter for which a derivative is to be calculated is x, the first information includes 0 and 1, and the second information is 0. Correspondingly, the primitive function is converted to the target function according to the first information and the second information through the function conversion interface. The target function is configured to output the result obtained by the plurality of parallel computations of the primitive function, and is further configured to output the derivative information of the primitive function relative to the second input parameter.

In some embodiments, the function conversion interface includes a first interface and a second interface, the first interface being configured to convert the primitive function to the target function according to the first information; and the second interface being configured to convert the primitive function to the target function according to the first information and the second information. That is to say, the first interface is a function conversion interface that supports the vector parallelism function, or the first interface is a function conversion interface that supports only the vector parallelism function. The second interface is a function conversion interface that supports the vector parallelism function and the automatic differentiation function.

Exemplarily, the first interface is a vmap interface, and a function signature of the vmap interface is exemplified as follows: vmap(f: Callable[ . . . , Any], vectorized_argnums: Union[int, Sequence[int]]=0)→Callable[ . . . , Any]. f represents the to-be-parallelized primitive function, and vectorized_argnums is used for indicating the first input parameter that needs to be parallelized, such as the location of the first input parameter that needs to be parallelized. In the function signature of the vmap interface, f: Callable[ . . . , Any] indicates that the primitive function f may be a function for which any input and output may be tensors; vectorized_argnums: Union[int, Sequence[int]]=0 indicates that vectorized_argnums may be a numerical value (such as 0 or 1, 2 or 3), or may be a series of numerical values (such as 0, 1 or 0, 1, 2 or 1, 2), and a default value of vectorized_argnums is 0. The output is defined as Callable [ . . . , Any].

FIG. 2 is an exemplary functional diagram of the vmap interface. For any primitive function f (such as a primitive function for which any input and output are tensors), another target function f will be outputted after function conversion through the vmap interface. f′=vmap(f,vectorized_argnums=(0,1)). vectorized_argnums=(0,1) indicates that the location number of the first input parameter in the primitive function f that needs to be parallelized includes 0 and 1, which means that x and y need to be parallelized while w does not need to be parallelized. An input format (that is, a type and a shape of the input parameter) of the target function f′ is the same as an input format of the primitive function f, except that a shape of a tensor corresponding to the input parameter at the location indicated by vectorized_argnums has one more dimension than a shape of the corresponding input tensor of the primitive function f (, that is, a vertical dimension in FIG. 2, which does not exist in the primitive function f). A size of the dimension is set to n, and n is an integer greater than 1. n may also be referred to as a batch size. The target function f′ obtained through the conversion by the vmap interface has a final computing effect equivalent to n computations of the primitive function f Each input to the primitive function f is a slice that is one dimension lower than one of a parameter at a non-vectorized_argnums location and a parameter at a vectorized_argnums location. Tensors of the same color in FIG. 2 form a slice, as shown by a dashed-line box in FIG. 2. Put simply, the n calls to the primitive function f may be fused into a unified operator at the underlying layer for parallel and simultaneous computation.

Exemplarily, the second interface is a vectorized_value_and_grad interface, which may be abbreviated as a vvag interface. A function signature of the vvag interface is exemplified as follows: vectorized_value_and_grad(f: Callable[ . . . , Any], argnums: Union[int, Sequence[int]]=0, vectorized_argnums: Union[int, Sequence[int]]=0)→Callable[ . . . , Tuple[Tensor, Tensor]]. f represents the to-be-parallelized primitive function, vectorized_argnums is used for indicating the first input parameter that needs to be parallelized, such as the location of the first input parameter that needs to be parallelized, and argnums is used for indicating the second input parameter for which a derivative is to be calculated, such as the location of the second input parameter for which a derivative is to be calculated. In the function signature of the vvag interface, f: Callable[ . . . , Any] indicates that the primitive function f may be a function for which any input and output may be tensors; vectorized_argnums: Union[int, Sequence[int]]=0 indicates that vectorized_argnums may be a numerical value (such as 0 or 1, 2 or 3), or may be a series of numerical values (such as 0, 1 or 0, 1, 2 or 1, 2), and a default value of vectorized_argnums is 0; and argnums: Union[int, Sequence[int]]=0 indicates that argnums may be a numerical value (such as 0 or 1, 2 or 3), or may be a series of numerical values (such as 0, 1 or 0, 1, 2 or 1, 2), and a default value of argnums is 0. The output is defined as Callable[ . . . , Tuple[Tensor, Tensor]], which indicates that the output includes 2 tensors. One tensor is the result of the plurality of parallel computations of the primitive function f, and the other tensor is derivative information of the primitive function f relative to the input parameter at the location indicated by argnums.

For any primitive function f (such as a primitive function for which any input and output are tensors), another target function f will be outputted after function conversion through the vvag interface. A shape of a tensor corresponding to the input parameter of the target function f′ at the location indicated by vectorized_argnums has one more dimension than a shape of the corresponding input tensor of the primitive function f. This function is the same as that of the vmap interface. The returning of the target function f′ obtained through the conversion by the vvag interface includes not only returning of the result of the plurality of parallel computations of the primitive function f, but also returning of the derivative information of the primitive function f relative to the input parameter at the location indicated by argnums.

Exemplarily, a mathematical expression corresponding to the vvag interface is as follows. The primitive function is f, and the target function f obtained by converting the primitive function f through the vvag interface is f′:

$${f}^{′} = vvag ( f , argnums = k , vectorized\_argnums = p )$$

$${f}^{′} ( arg [ 0 ] , … , arg [ p ] , … , arg [ k ] , … ) = ( v , g )$$

$$vi = f ( arg [ 0 ] , … , arg [ p ] [ i ] , \text{…} , arg [ k ] , … )$$

$$g = \frac{\partial {\sum }_{i} v i}{\partial arg [ k ]} ( p \neq k )$$

$${g}_{i} = \frac{\partial {v}_{i}}{\partial arg [ k ] [ i ]} ( p = k )$$

argnums=k indicates that one of the input parameters of the primitive function f with a location number k is the input parameter for which a derivative is to be calculated. vectorized_argnums=p indicates that one of the input parameters of the primitive function f with a location number p is the input parameter that needs to be parallelized. arg[0], . . . , arg[p], . . . , arg[k], . . . represent the input parameters of the target function f′. The output of the target function includes two tensors v and g. v represents the result of the plurality of parallel computations of the primitive function f, and g represents the derivative information of the primitive function f relative to the input parameter at the location indicated by argnums. arg[p][i] represents an i^{th} slice in a tensor corresponding to the input parameter with the location number p after the conversion. If the parallelism size is n, a value of i is an integer in an interval [0, n−1]. When p≠k,

$$g = \frac{\partial {\sum }_{i} v i}{\partial arg [ k ]} .$$

When p=k,

$${g}_{i} = \frac{\partial {v}_{i}}{\partial arg [ k ] [ i ]} .$$

In the above embodiment, the first interface being the vmap interface and the second interface being the vvag interface are used as examples, and the two interfaces with different functional interfaces provided in this disclosure are described. The names of the above two interfaces are not limited in this embodiment of this disclosure, and may be set by the developers.

In some embodiments, the function conversion interface is an API encapsulated above a machine learning library, the machine learning library being configured to provide a vector instruction set for executing the target function. For example, the underlying machine learning library may be a machine learning library such as tensorflow or jax. The underlying machine learning library provides the vector instruction set for executing the target function, and the function conversion interface is encapsulated above the machine learning library, thereby ensuring that the implementation of the vector parallelism is independent of the underlying framework. Simply calling the function conversion interface can implement the vector parallelism.

In step 340, vector parallelism is performed on the tensor corresponding to the converted first input parameter by using a vector instruction set, to obtain an execution result corresponding to the target function.

After the primitive function is converted to the target function through the function conversion interface, the vector instruction set provided by the underlying machine learning library may be further called. The vector instruction set is executed on hardware such as a CPU, a GPU, or a TPU, to perform the vector parallelism on the tensor corresponding to the converted first input parameter, so as to obtain the execution result corresponding to the target function. The vector instruction set includes an executable instruction for a processor to perform the vector parallelism on the tensor corresponding to the converted first input parameter. The above vector instruction set provides executable instructions that may be executed by processors such as the CPU, the GPU, or the TPU, which can implement functions of underlying operators such as addition and multiplication. In this embodiment, the vector parallelism is implemented by executing the vector instruction set on the processors such as the CPU, the GPU or the TPU, which can overcome the bottleneck of a parallelism number and fully improve the parallelism size compared with executing a plurality of processes or threads on an operating system.

In step 350, the quantum circuit simulation is performed based on the execution result corresponding to the target function.

After the execution result corresponding to the target function is obtained, the quantum circuit simulation may be performed. Step 350 may be the same as step 140 in the embodiment shown in FIG. 1. For an exemplary implementation, reference may be made to the description in the embodiment shown in FIG. 1.

In the technical solution provided in this disclosure, the function conversion interface is called to transmit, to the function conversion interface, the primitive function and the first information used for indicating the first input parameter in the primitive function that needs to be parallelized, so that the primitive function can be converted to the target function through the function conversion interface to implement the vector parallelism, thereby improving the computing efficiency of the primitive function, and thus improving the efficiency of the quantum circuit simulation.

In addition, in some embodiments, the function conversion interface not only supports the vector parallelism function, but also supports the automatic differentiation function, so that the target function converted by the function conversion interface is not only configured to output the result of the plurality of parallel computations of the primitive function, but also to output derivative information of the primitive function relative to a second input parameter. This is particularly suitable for a scenario of a variational quantum algorithm, which facilitates the development and research of the variational quantum algorithm.

A scenario of applying the vector parallelism to the quantum circuit simulation is described below. In this embodiment of this disclosure, the vector parallelism may be applied to the steps of the quantum circuit simulation such as processing the input wave function, optimizing the circuit variation parameter, generating the circuit noise, generating the circuit structure, and performing the circuit measurement. These application scenarios are described below through a plurality of embodiments.

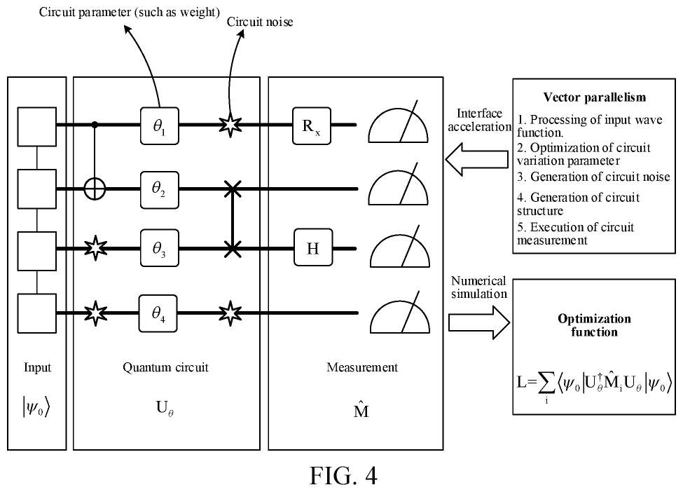

FIG. 4 is an exemplary schematic diagram of numerical simulation of a target quantum circuit. The target quantum circuit can implement numerical simulation of a variational quantum algorithm. By using the technical solution provided in this disclosure, all major components of the simulation can skillfully support vector parallelism, thereby significantly accelerating quantum simulation in different application scenarios. As shown in FIG. 4, a process that needs to be simulated and computed includes: inputting a specified quantum state (which may be in the form of a matrix product state or a vector). Then an output state is measured on different bases in the form of a measured Pauli string by a parameter-containing and possibly noise-containing quantum circuit, so as to obtain an optimized function value and a gradient about a weight for optimization iteration.

In FIG. 4, an input quantum state of the target quantum circuit is represented as |ψ₀ [symbol] , a circuit parameter of the target quantum circuit is represented as U_{θ}, a measurement result is represented as \hat{M}, and an optimization function is represented as

$$L = {\sum }_{i} 〈 {ψ}_{0} \vert {U}_{θ}^{†} {\hat{M}}_{i} {U}_{θ} \vert {ψ}_{0} 〉 .$$

\hat{M}ᵢ represents an i^{th} measurement result, i is an integer, and U_{θ}^{†} represents conjugate transpose of U_{θ}.

1. Parallelized Processing of an Input Wave Function.

In this example, the primitive function is configured to implement a target step in the quantum circuit simulation. The target step includes processing the input wave function, and the first input parameter includes an input wave function of the target quantum circuit.

In some embodiments, the tensor corresponding to the converted first input parameter is acquired, the tensor corresponding to the converted first input parameter being a result obtained by splicing a plurality of parallelized input wave functions of the target quantum circuit; and the vector parallelism is performed on the tensor corresponding to the converted first input parameter by using the vector instruction set, to obtain the execution result corresponding to the target function, the execution result corresponding to the target function including processing results respectively corresponding to the plurality of parallelized input wave functions.

Taking variational quantum circuit simulation as an example, the variational quantum circuit simulation is composed of three parts: an input wave function, a circuit unitary matrix, and circuit measurement. In many tasks, the input wave function of the circuit is an all 0 direct product state, and in this case, the input wave function does not need to be specified. However, in some tasks, the same circuit structure may be required to accept different input wave function for processing and output. In this case, it is very suitable to perform vector parallelism on the input wave function parameter for simulation.

For example, in a quantum machine learning task, an inputted data set needs to be processed in batches, and each time a result of a batch of inputted data needs to be computed. The batch of data is encoded into a wave function and entered into a quantum machine learning model in the form of the input wave function. Therefore, parallelized processing of the input wave function can help process the batch input of quantum machine learning and achieve acceleration under a large batch size. Numerical experiments show that on a GPU, a batch size=512 and a batch size=1 require almost the same computing time. This benefits from the underlying architecture optimization of the vector parallelism, which is equivalent to directly accelerating the simulation by times of a batch size.

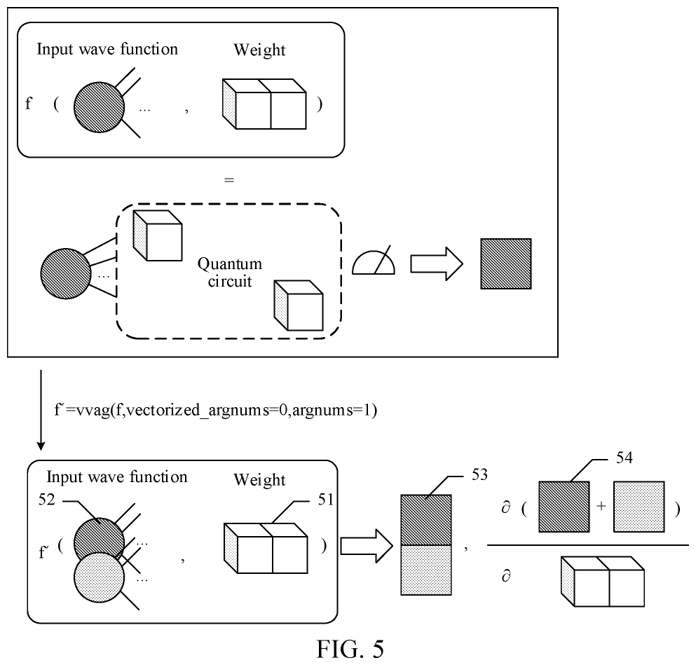

FIG. 5 is a schematic diagram of parallelized processing of an input wave function. The vvag interface described in the above is used as an example. The target function f=vvag(f,vectorized_argnums=0, argnums=1), f being the primitive function, vectorized_argnums=0 indicating that the input parameter that needs to be parallelized is the input wave function of the target quantum circuit, and argnums=1 indicating that the input parameter for which a derivative is to be calculated is a weight of the target quantum circuit. The input parameter of the target function f′ includes a weight 51 of the target quantum circuit and a result 52 obtained by splicing a plurality of parallelized input wave functions of the target quantum circuit. The target function f′ is executed through the vector parallelism, to obtain processing results 53 respectively corresponding to the plurality of parallelized input wave functions and derivative information 54 of the weight. Subsequently, steps such as optimizing the circuit variation parameter may be performed based on the processing results respectively corresponding to the plurality of parallelized input wave functions. For example, the circuit variation parameter of the target quantum circuit may be adjusted according to a difference between the processing results corresponding to the input wave functions and expected results, so that the processing results corresponding to the input wave functions approximate the expected results as much as possible.

In this example, through the parallelized processing of the input wave functions, the batch processing efficiency of the input wave functions in the quantum circuit simulation process is fully improved.

2. Parallelized Optimization of a Circuit Variation Parameter.

In this example, the primitive function is configured to implement a target step in the quantum circuit simulation. The target step includes optimizing the circuit variation parameter, and the first input parameter includes a circuit variation parameter of the target quantum circuit.

In some embodiments, the tensor corresponding to the converted first input parameter is acquired, the tensor corresponding to the converted first input parameter being a result obtained by splicing a plurality of groups of parallelized circuit variation parameters of target quantum circuit; and the vector parallelism is performed on the tensor corresponding to the converted first input parameter by using the vector instruction set, to obtain the execution result corresponding to the target function, the execution result corresponding to the target function including optimization results respectively corresponding to the plurality of groups of parallelized circuit variation parameters.

For the variational quantum optimization, parameters with gradient descent often remain at a local minimum. This requires a plurality of independent optimizations on the same problem from different initial parameters, and requires selection of a group of corresponding parameters that make the optimization function optimal. The plurality of independent optimizations increase the time consumption by times of an optimization number in the simple loop solution. In this case, the vector parallelism may be performed on variables corresponding to the circuit variation parameters.

This embodiment of this disclosure proposes parallel acceleration for the plurality of independent optimizations. In particular, for algorithms prone to remain at a local minimum such as a VQE, a plurality of parallel optimizations are performed simultaneously, and then the most suitable convergence parameter is finally selected. In this way, the time for the plurality of optimizations is almost identical to the time for a single optimization. This optimization solution is referred to as batched VQE optimization. That is to say, parallel execution of the plurality of independent optimization may be implemented from the underlying operator.

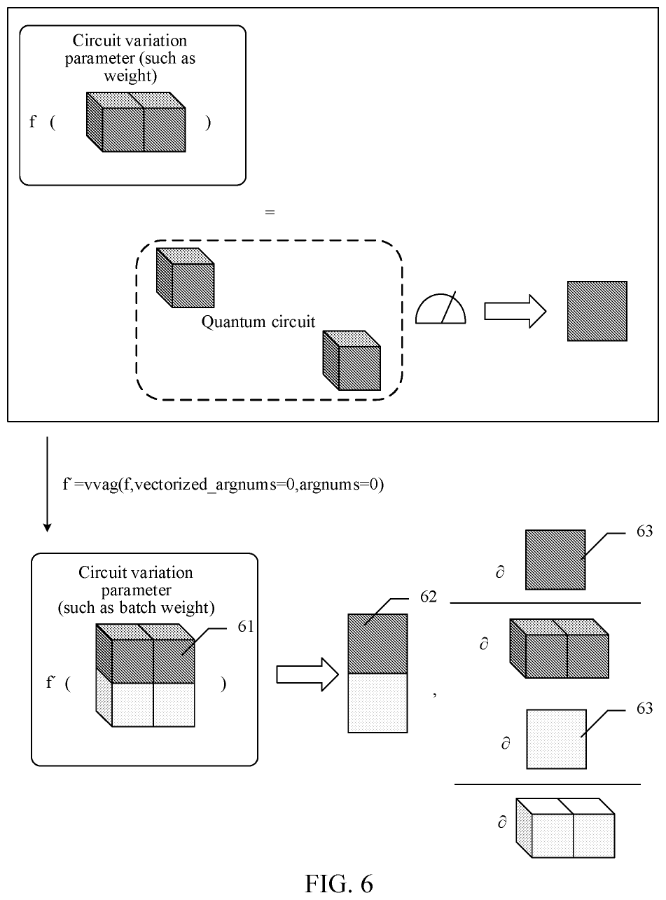

FIG. 6 is a schematic diagram of parallelized optimization of a circuit variation parameter. The vvag interface described in the above is used as an example. The target function f=vvag(f,vectorized_argnums=0, argnums=0), f being the primitive function, vectorized_argnums=0 indicating that the input parameter that needs to be parallelized is the circuit variation parameter (such as the weight) of the target quantum circuit, and argnums=0 indicating that the input parameter for which a derivative is to be calculated is also the circuit variation parameter (such as the weight) of the target quantum circuit. The input parameter of the target function f′ includes a result 61 obtained by splicing a plurality of groups of parallelized circuit variation parameters of the target quantum circuit. The target function f′ is executed through the vector parallelism, to obtain optimization results 62 respectively corresponding to the plurality of groups of parallelized circuit variation parameters and derivative information 63 of the circuit variation parameters. Subsequently, an optimal group of circuit variation parameters may be selected as a final parameter of the target quantum circuit according to the optimization results respectively corresponding to the plurality of groups of parallelized circuit variation parameters.

In this example, through the parallelized optimization of the circuit variation parameters, the optimization efficiency of the circuit variation parameters in the quantum circuit simulation process is fully improved.

3. Parallelized Generation of Circuit Noise.

In this example, the primitive function is configured to implement a target step in the quantum circuit simulation. The target step includes generating circuit noise, and the first input parameter includes a random number used for generating circuit noise of the target quantum circuit.

In some embodiments, the tensor corresponding to the converted first input parameter is acquired, the tensor corresponding to the converted first input parameter being a result obtained by splicing a plurality of groups of parallelized random numbers used for generating circuit noise of the target quantum circuit; and the vector parallelism is performed on the tensor corresponding to the converted first input parameter by using the vector instruction set, to obtain the execution result corresponding to the target function, the execution result corresponding to the target function including noise simulation results respectively corresponding to the plurality of groups of parallelized random numbers. Subsequently, execution results of the target quantum circuit under noise simulation results corresponding to different random numbers may be observed to obtain execution statuses of the target quantum circuit in different noise environments and difference between the execution results.

In a scenario of a Monte Carlo trajectory simulator, a behavior of using different random numbers to simulate noise with different probability distributions is performed. Since evaluating observed quantities by using the Monte Carlo trajectory simulator requires averaging of a large number of observation and measurement results from different random number configurations, naturally, the random number parameters may be parallelized to implement simultaneous simulation of dozens or even hundreds of random configurations. Therefore, the solution of this disclosure may be used for accelerating the Monte Carlo simulation of quantum noise. Different random number inputs are parallelized, to implement vectorized parallelism of the Monte Carlo simulation of noise. The behavior of using the random number as a parallel dimension is similar to that of using the input wave function as a parallel dimension, and therefore the schematic diagram is not shown separately.

In this example, through the parallelized generation of the circuit noise, the generation efficiency of the circuit noise in the quantum circuit simulation process is fully improved.

In the above three cases, the vmap or vvag interface may be directly called without any special processing on the to-be-implemented function, and the location of the input parameter that needs to be parallelized may be specified as the parameter vectorized_argnums in the API, so as to be converted to an efficient simulation supporting vector parallelism.

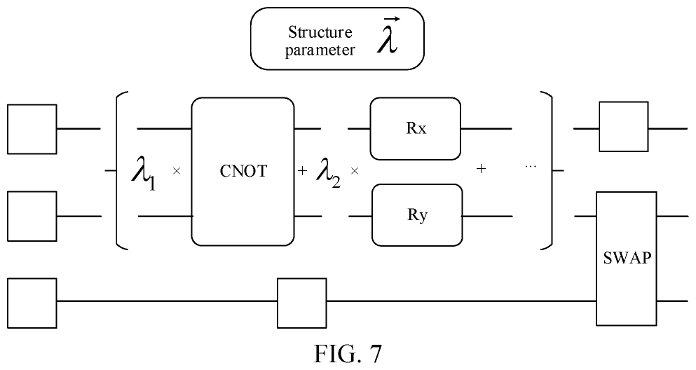

In the following two situations, it is necessary to implement parameterized summation of tensors based on a circuit simulator based on a tensor network, so that different input parameters correspond to different reduced tensor network structures. The idea of parameterizing the summation of local tensors and keeping the same local tensor shape so as to be embedded into a global tensor network to implement parameterized control of simulation of different tensor network structures (or quantum circuit structures) is shown in FIG. 7. FIG. 7 shows a fragment of a tensor network including parameterized structural information. \vec{X} is a structural parameter. When different one-hot vectors are used as \vec{λ}, in the tensor network, the local tensor of interest can be a controlled NOT (CNOT) gate direct product (\vec{λ}=(1, 0, . . . )) or can be a single bit rotation gate direct product (\vec{λ}=(0, 1, . . . )). For parameterized structural simulation of more sub-blocks, only an independent structural parameter vector \vec{λ} needs to be introduced in each local area. Measurement parameterization is similar, as long as the local tensor at the measurement position is selected as

$${\sum }_{i = 0}^{3} {λ}_{i} {σ}_{i} .$$

λᵢ represents a group of four-dimensional vectors corresponding to an i^{th} qubit, σ₀=I (the operator I is

$$[ \begin{matrix}1 & 0 \\ 0 & 1\end{matrix} ] ) ,$$

and σ₁, σ₂, and σ₃ correspond to Pauli matrices X, Y, and Z. In this case, the Pauli string corresponding to the final measurement may be directly controlled by transmitting a group of parameter tensors with the shape of [qubits, 4]. All computing processes and real-time compiled computing graphs are identical and may be reused. For example, measurement parameters [[1,0,0,0], [0,1,0,0], and [0,0,0,1]] indicate that the to-be-measured expected Pauli string is I₀X₁Z₂, which is simplified as X₁Z₂. What's more, the above solution does not change the overall static structure of the tensor network, which can still perfectly support real-time compiling and pre-optimized search of tensor contraction paths.

4. Parallelized Generation of a Circuit Structure.

In this example, the primitive function is configured to implement a target step in the quantum circuit simulation. The target step includes generating a circuit structure. The first input parameter includes a control parameter used for generating a circuit structure of the target quantum circuit, and a different control parameter is used for generating a different circuit structure.

In some embodiments, the tensor corresponding to the converted first input parameter is acquired, the tensor corresponding to the converted first input parameter being a result obtained by splicing a plurality of groups of parallelized control parameters used for generating circuit structure of the target quantum circuit; and the vector parallelism is performed on the tensor corresponding to the converted first input parameter by using the vector instruction set, to obtain the execution result corresponding to the target function, the execution result corresponding to the target function including circuit structure generation results respectively corresponding to the plurality of groups of parallelized control parameters.

In order to implement parallelism of different circuit structures, it is necessary to underutilize the characteristic that the underlying simulator is based on the tensor network. For circuit parts that may have different structures, parameterized summation is performed on tensors representing different structures. That is to say, these parameters can control the circuit structure while satisfying the limitations of real-time compiling. The reason is that even if the circuit structure changes, since a super network represented by the most generalized parameterized summation has already summarized all possibilities with fixed tensor shapes, real-time compiling can still be normally implemented.

DARTS inspired differentiable quantum structure search includes a task of evaluating target optimization functions corresponding to a large number of different circuit structures in a batch, which perfectly matches the situation of parallelized circuit structures. Therefore, quantum software with vector parallelization will significantly improve the efficiency of differentiable quantum structure search, that is, automatic variational circuit design. This is a parallel paradigm that is unique to tensor simulators and uneasily implemented in state simulators.

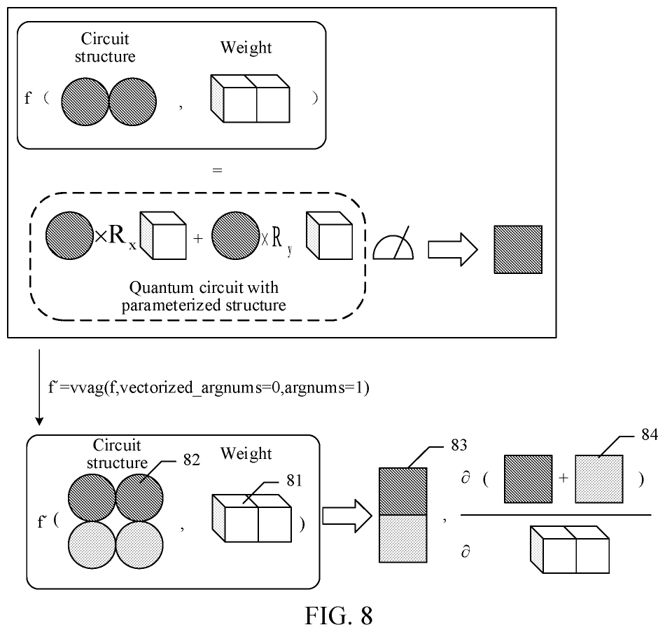

FIG. 8 is an exemplary schematic diagram of parallelized generation of a circuit structure. The vvag interface described in the above is used as an example. The target function f′=vvag(f,vectorized_argnums=0, argnums=1), f being the primitive function, vectorized_argnums=0 indicating that the input parameter that needs to be parallelized is a control parameter for a circuit structure of the target quantum circuit, and argnums=1 indicating that the input parameter for which a derivative is to be calculated is a weight of the target quantum circuit. The input parameter of the target function f includes a weight 81 of the target quantum circuit and a result 82 obtained by splicing a plurality of groups of parallelized control parameters for the circuit structure of the target quantum circuit. The target function f is executed through the vector parallelism, to obtain circuit structure generation results respectively corresponding to the plurality of groups of parallelized control parameters. Based on the plurality of groups of circuit structure generation results, a plurality of groups of measurement results 83 as well as derivative information 84 of the measurement results relative to the weight may be obtained. Subsequently, an optimal circuit structure generation result may be selected from the above plurality of groups of circuit structure generation results, and the target quantum circuit may be deployed in the actual hardware on this basis.

In this example, through the parallelized generation of the circuit structure, the generation efficiency of the circuit structure in the quantum circuit simulation process is fully improved.

5. Parallelized Execution of Circuit Measurement.

In this example, the primitive function is configured to implement a target step in the quantum circuit simulation. The target step includes performing circuit measurement. The first input parameter includes a measurement parameter used for performing circuit measurement on the target quantum circuit, and a different measurement parameter is used for generating a different measurement result.

In some embodiments, the tensor corresponding to the converted first input parameter is acquired, the tensor corresponding to the converted first input parameter being a result obtained by splicing a plurality of groups of parallelized measurement parameters used for performing the circuit measurement on the target quantum circuit; and the vector parallelism is performed on the tensor corresponding to the converted first input parameter by using the vector instruction set, to obtain the execution result corresponding to the target function, the execution result corresponding to the target function including measurement results respectively corresponding to the plurality of groups of parallelized measurement parameters. Subsequently, an execution result of the target quantum circuit may be observed based on the measurement results corresponding to plurality of groups of measurement parameters.

For a small-sized system, the numerical simulation may completely preserve the wave function information of a final state output of the quantum circuit. In this case, many different solutions are available for the numerical simulation of the measurement results. The solutions include reusing the wave function information and computing expectations of different Pauli string operators on the wave function according to the wave function information. In addition, when smaller systems can fully represent a matrix form of a Hamiltonian operator in a memory, summations of Pauli strings may be directly combined into an independent Hamiltonian matrix to compute the expectations, which is usually more efficient.

However, for large-sized systems that may be supported by only the tensor network simulator, a final wave function cannot be reused (since there is no enough memory space for storage) for different Pauli strings. In addition, during solving of different operator expectations by contradicting the tensor networks in sequence, it is necessary to search for the contradiction path again and perform real-time compiling, which wastes a lot of time. Therefore, the solution of parameterized circuit structure summation may be simulated to implement parameterized circuit measurement summation. In this way, the Pauli string of the corresponding measurement operator may be controlled by using the one-hot vector of the input parameter. In this case, only one real-time compiling is required to support the solution of the expectations of all different Pauli strings. In combination with the vector parallelism of the structural parameters in the measurement, the expectations of a plurality of Pauli strings may be efficiently computed simultaneously without a need to recompile (in real-time) each different measurement operator.

In this example, when the memory cannot store the complete wave function and thus the wave function cannot be fully used to evaluate different Pauli strings, efficient large-scale circuit simulation can be implemented through the vector parallelism of the parameterized circuit measurements.

The application scenarios and the corresponding acceleration effects of the technical solution in this disclosure have been mentioned above. Generally speaking, on hardware such as a GPU, vector parallelism can substantially achieve an acceleration consistent with the size of the parallel batch dimension. This can achieve efficiency improvements ranging from tens to hundreds of times compared to simple loop computation in common scenarios, and the required additional development costs may be negligible, which is user-friendly. The significance of improving the efficiency is emphasized through some simple quantitative results.

1. Accelerating a Quantum Machine Learning Task.

As mentioned above, in the machine learning task, the input data needs to be processed in batch, to implement vector parallelism of the parameters of the input wave function, which can significantly improve the computing efficiency of the quantum machine learning. Different mainstream quantum software simulates the same parameterized circuit for MNIST discrimination, and the time consumed in a single step varies with the batch size, as shown in FIG. 9. A line 91 shows a variation of the execution time with the batch size on the GPU using the vector parallelism solution provided in this disclosure, a line 92 shows a variation of the execution time with the batch size on the CPU using the vector parallelism solution provided in this disclosure, a line 93 shows a variation of the execution time with the batch size using a pennylane solution, and a line 94 shows a variation of the execution time with the batch size using a tensorflow-quantum solution. It may be learned that the vector parallelism technology provided in this disclosure can achieve acceleration over a hundred times compared to other mainstream software on the GPU when the batch size is large.

2. Measurement Parallelism Implements Efficient Simulation of an Ultra Large Quantum System.

Implementing the reuse of different Pauli string measurement computing graphs by using the vector parallelism technology when the wave function cannot be reused can implement simulation of more than 100 bits of quantum chemistry ground state simulation VQEs on a single V100. It is the first time in the world to show and simulate the entire process of variational quantum algorithms in such a large system. Corresponding simulation convergence results of one-dimensional transverse field Ising model phase transition points and one-dimensional isotropic Heisenberg model at 100 grids are shown in the following Table 1. For large-scale problems such as a 100 grid VQE, the time required for a single optimization iteration is only on the order of seconds, and the simulation task cannot be implemented by mainstream simulators based on the quantum state due to memory exponential divergence.

TABLE 1

| | Double bit | | Ground state |
|---|---|---|---|
| N = 100 | gate layers | Single step time | energy error |
| One-dimensional | 6 | 8.5 s | 0.5% |
| Heisenberg model | | | |
| One-dimensional transverse | 7 | 8.6 s | 0.1% |
| field Ising model | | | |

The solution described in this disclosure is based on the self-developed TensorCircuit quantum simulation framework. TensorCircuit is a new generation of quantum computing simulation software based on the modern machine learning framework, which supports a multi-hardware platform and a multi-software backend, and also supports automatic differentiation, real-time compiling, vector parallelism, and heterogeneous hardware acceleration. TensorCircuit is particularly suitable for the design, research, and development of algorithms in the NISQ era, and perfectly supports the simulation of quantum classical hybrid computing paradigms. TensorCircuit is entirely written in pure Python, and uses the tensor network as the core engine in the algorithm, which has higher running efficiency than optimized C++ code while maintaining user friendliness. The solution presented in this disclosure has been fully implemented under the TensorCircuit framework, and may be directly used, and achieves much higher efficiency than similar software.

The solution of this disclosure and the TensorCircuit platform can significantly accelerate and enhance the verification development of quantum hardware and the design and testing of quantum software and algorithms in the NISQ period. The solution has laid a foundation for demonstrating effective quantum advantages on NISQ hardware and verifying problems related to large-scale variational quantum computing, and increase a possibility of commercial application of quantum computers and quantum heuristics.

Apparatus embodiments of this disclosure are described below, which may be used for performing the method embodiments of this disclosure. For details not disclosed in the apparatus embodiments of this disclosure, refer to the above embodiments of this disclosure.

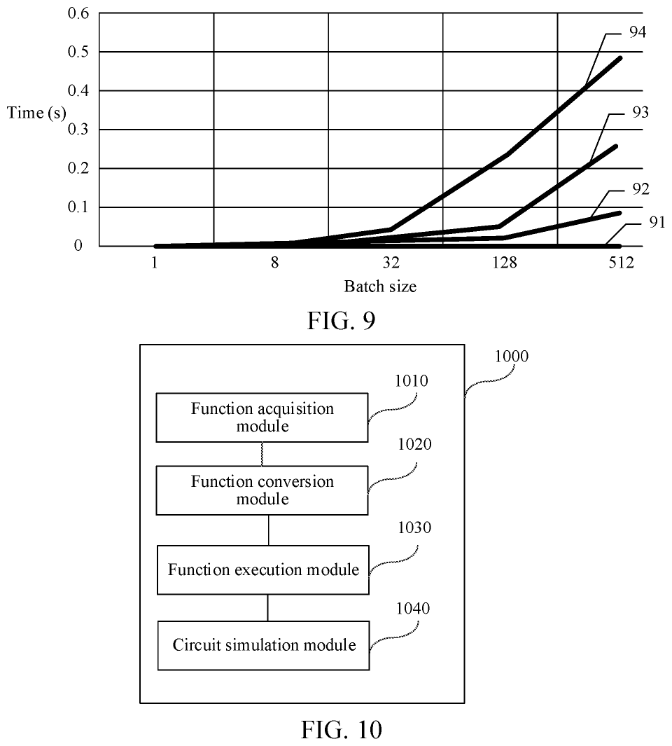

FIG. 10 is a block diagram of a quantum circuit simulation apparatus according to an embodiment of this disclosure. The apparatus has a function of implementing the above quantum circuit simulation method, and the function may be implemented by hardware or by hardware by executing corresponding software. The apparatus may be a computer device, or may be arranged in the computer device. The apparatus 1000 may include a function acquisition module 1010, a function conversion module 1020, a function execution module 1030, and a circuit simulation module 1040.

The function acquisition module 1010 is configured to acquire a primitive function for quantum circuit simulation, and determine a first input parameter in the primitive function that needs to be parallelized.

The function conversion module 1020 is configured to convert the primitive function to a target function according to the primitive function and the first input parameter, the input parameter of the target function including a converted first input parameter corresponding to the first input parameter, and a tensor corresponding to the converted first input parameter being a result obtained by splicing a plurality of parallelized tensors corresponding to the first input parameter.

The function execution module 1030 is configured to obtain an execution result corresponding to the target function according to the input parameter of the target function.

The circuit simulation module 1040 is configured to perform the quantum circuit simulation based on the execution result corresponding to the target function.

In an exemplary embodiment, the function execution module 1030 is configured to process the converted first input parameter included in the input parameter of the target function through vector parallelism, to obtain the execution result corresponding to the target function.

In an exemplary embodiment, the function execution module 1030 is configured to perform the vector parallelism on the tensor corresponding to the converted first input parameter by using a vector instruction set, to obtain the execution result corresponding to the target function, the vector instruction set including an executable instruction for a processor to perform the vector parallelism on the tensor corresponding to the converted first input parameter.

In some embodiments, the primitive function is configured to implement an operation processing an input wave function in the quantum circuit simulation, and the first input parameter includes an input wave function of a target quantum circuit. The function execution module 1030 is configured to: acquire the tensor corresponding to the converted first input parameter, the tensor corresponding to the converted first input parameter being a result obtained by splicing a plurality of parallelized input wave functions of the target quantum circuit; and perform the vector parallelism on the tensor corresponding to the converted first input parameter by using the vector instruction set, to obtain the execution result corresponding to the target function, the execution result corresponding to the target function including processing results respectively corresponding to the plurality of parallelized input wave functions.

In some embodiments, the primitive function is configured to implement an operation of optimizing a circuit variation parameter in the quantum circuit simulation, and the first input parameter includes a circuit variation parameter of a target quantum circuit. The function execution module 1030 is configured to: acquire the tensor corresponding to the converted first input parameter, the tensor corresponding to the converted first input parameter being a result obtained by splicing a plurality of groups of parallelized circuit variation parameters of the target quantum circuit; and perform the vector parallelism on the tensor corresponding to the converted first input parameter by using the vector instruction set, to obtain the execution result corresponding to the target function, the execution result corresponding to the target function including optimization results respectively corresponding to the plurality of groups of parallelized circuit variation parameters.

In some embodiments, the primitive function is configured to implement an operation of generating circuit noise in the quantum circuit simulation, and the first input parameter includes a random number used for generating circuit noise of a target quantum circuit. The function execution module 1030 is configured to: acquire the tensor corresponding to the converted first input parameter, the tensor corresponding to the converted first input parameter being a result obtained by splicing a plurality of groups of parallelized random numbers used for generating the circuit noise of the target quantum circuit; and perform the vector parallelism on the tensor corresponding to the converted first input parameter by using the vector instruction set, to obtain the execution result corresponding to the target function, the execution result corresponding to the target function including noise simulation results respectively corresponding to the plurality of groups of parallelized random numbers.

In some embodiments, the primitive function is configured to implement an operation of generating a circuit structure in the quantum circuit simulation, the first input parameter includes a control parameter used for generating a circuit structure of a target quantum circuit, and a different control parameter is used for generating a different circuit structure. The function execution module 1030 is configured to: acquire the tensor corresponding to the converted first input parameter, the tensor corresponding to the converted first input parameter being a result obtained by splicing a plurality of groups of parallelized control parameters used for generating the circuit structure of the target quantum circuit; and perform the vector parallelism on the tensor corresponding to the converted first input parameter by using the vector instruction set, to obtain the execution result corresponding to the target function, the execution result corresponding to the target function including circuit structure generation results respectively corresponding to the plurality of groups of parallelized control parameters.

In some embodiments, the primitive function is configured to implement an operation of performing circuit measurement in the quantum circuit simulation, and the first input parameter includes a measurement parameter used for performing circuit measurement on a target quantum circuit, a different measurement parameter being used for generating a different measurement result. The function execution module 1030 is configured to: acquire the tensor corresponding to the converted first input parameter, the tensor corresponding to the converted first input parameter being a result obtained by splicing a plurality of groups of parallelized measurement parameters used for performing the circuit measurement on the target quantum circuit; and perform the vector parallelism on the tensor corresponding to the converted first input parameter by using the vector instruction set, to obtain the execution result corresponding to the target function, the execution result corresponding to the target function including measurement results respectively corresponding to the plurality of groups of parallelized measurement parameters.

In an exemplary embodiment, the target function is obtained in the following way:
modifying the first input parameter in the primitive function to the converted first input parameter and retaining a target input parameter that does not need to be parallelized when the input parameter of the primitive function further includes the target input parameter, to obtain the target function;
or
modifying the first input parameter in the primitive function to the converted first input parameter when the input parameter of the primitive function does not include the target input parameter that does not need to be parallelized, to obtain the target function.

In an exemplary embodiment, the function conversion module 1020 is configured to: call a function conversion interface, and transmit the primitive function and first information to the function conversion interface, the first information being used for indicating the first input parameter in the primitive function that needs to be parallelized; and convert the primitive function to the target function according to the first information through the function conversion interface.

In some embodiments, the function conversion module 1020 is configured to: transmit second information to the function conversion interface, the second information being used for indicating a second input parameter in the primitive function for which a derivative is to be calculated; and convert the primitive function to the target function according to the first information and the second information through the function conversion interface, the target function being further configured to output derivative information of the primitive function relative to the second input parameter.

In some embodiments, the function conversion interface includes a first interface and a second interface, the first interface being configured to convert the primitive function to the target function according to the first information; and the second interface being configured to convert the primitive function to the target function according to the first information and the second information.

In some embodiments, the function conversion interface is an API encapsulated above a machine learning library, the machine learning library being configured to provide a vector instruction set for executing the target function.

In an exemplary embodiment, a plurality of parallelized tensors corresponding to the first input parameter are spliced in a target dimension to obtain the tensor corresponding to the converted first input parameter, a size of the tensor corresponding to the converted first input parameter in the target dimension corresponds to a number of the parallelized tensors corresponding to the first input parameter.

In the technical solution provided in this disclosure, the idea of vector parallelism is introduced into the quantum circuit simulation. The primitive function is converted to the target function, the input parameter of the target function including the converted first input parameter corresponding to the first input parameter that needs to be parallelized, and the tensor corresponding to the converted first input parameter being the result obtained by splicing the plurality of parallelized tensors corresponding to the first input parameter. By executing the target function, a plurality of original computing processes can be parallelized into a single computing process, which can be completed in the same time as the single computation, thereby fully improving the efficiency of quantum circuit simulation.

During function implementation of the apparatus provided in the above embodiment, only division of the functional modules is illustrated. In actual application, the functions may be assigned to different functional modules for completion as required. In other words, an internal structure of the device is divided into different functional modules to complete all or some of the functions described above. In addition, the apparatus in the above embodiment belongs to the same idea as the method. For a specific implementation thereof, refer to the method embodiment, and the details are not described herein.

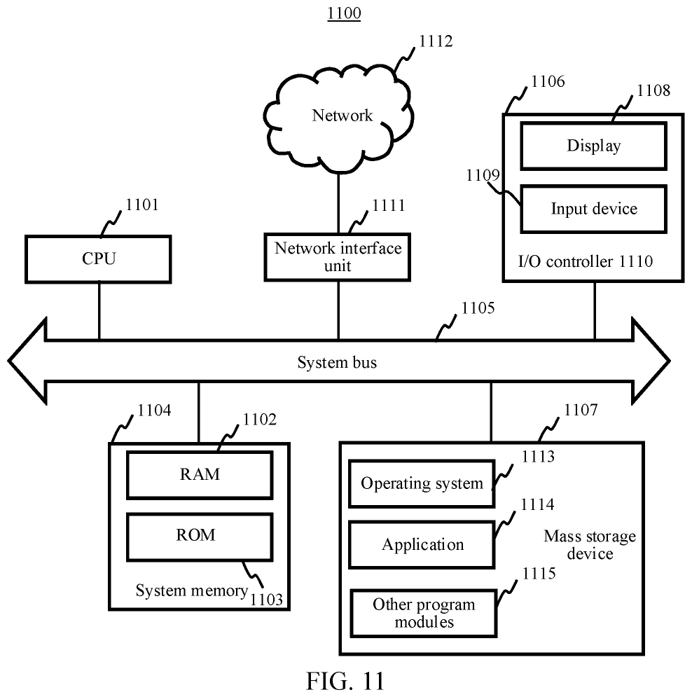

FIG. 11 is a schematic structural diagram of a computer device according to an embodiment of this disclosure. The computer device may be a classical computer. The computer device is configured to implement the quantum circuit simulation method provided in the above embodiments. Details are as follows:

The computer device 1100 includes a central processing unit (CPU), a graphics processing unit (GPU), and a field programmable gate array (FPGA) 1101, a system memory 1104 including a random access memory (RAM) 1102 and a read-only memory (ROM) 1103, and a system bus 1105 connected to the system memory 1104 and the CPU 1101. The computer device 1100 further includes a basic input/output system (I/O system) 1106 assisting information transmission between devices in the server, and a mass storage device 1107 configured to store an operating system 1113, an application program 1114, and other program modules 1115.

In some embodiments, the basic I/O system 1106 includes a display 1108 configured to display information and an input device 1109 such as a mouse and a keyboard for a user to input information. The display 1108 and the input device 1109 are both connected to the CPU 1101 through an I/O controller 1110 connected to the system bus 1105. The basic I/O system 1106 may further include the I/O controller 1110 for receiving and processing input from a plurality of other devices such as a keyboard, a mouse, or an electronic stylus. Similarly, the I/O controller 1110 further provides output to a display screen, a printer, or other types of output devices.

In some embodiments, the mass storage device 1107 is connected to the CPU 1101 through a mass storage controller (not shown) connected to the system bus 1105. The mass storage device 1107 and an associated computer-readable medium thereof provide non-volatile storage for the computer device 1100. In other words, the mass storage device 1107 may include a computer-readable medium (not shown) such as a hard disk or a compact disc read-only memory (CD-ROM) drive.

Without loss of generality, the computer-readable medium may include a computer storage medium and a communication medium. The computer storage medium includes volatile and non-volatile media, and removable and non-removable media implemented by using any method or technology used for storing information such as computer-readable instructions, data structures, program modules, or other data. The computer storage medium includes a RAM, a ROM, an erasable programmable read-only memory (EPROM), an electrically erasable programmable ROM (EEPROM), a flash memory or other solid-state storage technologies, a CD-ROM, a digital versatile disc (DVD) or other optical memories, a tape cartridge, a magnetic cassette, a magnetic disk memory, or other magnetic storage devices. The computer storage medium is not limited to the above embodiments. The above system memory 1104 and mass storage device 1107 may be collectively referred to as a memory.

According to the embodiments of this disclosure, the computer device 1100 may be further connected to a remote computer on a network for running through a network such as the Internet. In other words, the computer device 1100 may be connected to a network 1112 through a network interface unit 1111 connected to the system bus 1105, or may be connected to other types of networks or remote computer systems (not shown) through the network interface unit 1116.

The memory further includes a computer program. The computer program is stored in the memory and configured to be executed by one or more processors to implement the quantum circuit simulation method.

In an exemplary embodiment, a computer device is further provided. The computer device is configured to implement the above quantum circuit simulation method. In some embodiments, the computer device is a classical computer.

In an exemplary embodiment, a computer-readable storage medium (e.g., non-transitory computer readable storage medium) is further provided. The computer-readable storage medium stores a computer program. The computer program, when executed by a processor of a computer device, implements the above quantum circuit simulation method.

In some embodiments, the computer-readable storage medium may include a ROM, a RAM, a solid state drive (SSD), an optical disc, or the like. The RAM may include a resistance random access memory (ReRAM) and a dynamic random access memory (DRAM).

In an exemplary embodiment, a computer program product is further provided. The computer program product includes a computer program stored in a computer-readable storage medium. A processor of a computer device reads the computer program from the computer-readable storage medium, and the processor executes the computer program, to cause the computer device to perform the above quantum circuit simulation method.

It is to be understood that the term “a plurality of” in the description means two or more. “And/or” describes an association relationship between associated objects and indicates that three relationships may exist. For example, A and/or B may represent the following three cases: only A exists, both A and B exist, and only B exists. The character “/” generally indicates that the associated objects at front and rear are in an “or” relationship. In addition, the step numbers described herein merely exemplarily show a possible execution sequence of the steps. In some other embodiments, the steps may not be performed according to the number sequence. For example, two steps with different numbers may be performed simultaneously, or two steps with different numbers may be performed according to a sequence reverse to the sequence shown in the figure. This is not limited in the embodiments of this disclosure.

The term module (and other similar terms such as unit, submodule, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The above descriptions are merely exemplary embodiments of this disclosure, and are not intended to limit this disclosure. Any modification, equivalent replacement, or improvement made within the spirit and principle of this disclosure shall fall within the scope of this disclosure.

What is claimed is:

1. A method of a quantum circuit simulation, comprising:
receiving a primitive function for the quantum circuit simulation;
determining at least a first input parameter of the primitive function, the quantum circuit simulation including a plurality of first tensors respectively for the first input parameter;
converting the primitive function to a target function according to the primitive function and at least the first input parameter, the target function including a converted first input parameter corresponding to the first input parameter, the plurality of first tensors being spliced into a second tensor for the converted first input parameter in the quantum circuit simulation;
obtaining an execution result of the target function according to at least the second tensor for the converted first input parameter; and
performing the quantum circuit simulation based on the execution result of the target function.

2. The method according to claim 1, wherein the obtaining the execution result comprises:
processing the converted first input parameter through a vector parallelism, to obtain the execution result.

3. The method according to claim 2, wherein the processing the converted first input parameter comprises:
performing the vector parallelism on the second tensor for the converted first input parameter by using a vector instruction set, the vector instruction set comprising one or more executable instructions for a processor to perform the vector parallelism on the second tensor for the converted first input parameter.

4. The method according to claim 3, wherein the primitive function is configured to process an input wave function of a target quantum circuit in the quantum circuit simulation, and the performing the vector parallelism on the second tensor comprises:
splicing a plurality of input wave functions of the target quantum circuit into the second tensor for the converted first input parameter; and
performing the vector parallelism on the second tensor for the converted first input parameter by using the vector instruction set, to obtain processing results respectively corresponding to the plurality of input wave functions.

5. The method according to claim 3, wherein the primitive function is configured to optimize a group of circuit variation parameters of a target quantum circuit in the quantum circuit simulation, and the performing the vector parallelism on the second tensor for the converted first input parameter comprises:
splicing a plurality of groups of circuit variation parameters of the target quantum circuit into the second tensor for the converted first input parameter; and
performing the vector parallelism on the second tensor for the converted first input parameter by using the vector instruction set, to obtain optimization results respectively corresponding to the plurality of groups of circuit variation parameters.

6. The method according to claim 3, wherein the primitive function is configured to generate circuit noise of a target quantum circuit in the quantum circuit simulation according to a group of random numbers, and the performing the vector parallelism on the second tensor for the converted first input parameter comprises:
splicing a plurality of groups of random numbers into the second tensor for the converted first input parameter; and
performing the vector parallelism on the second tensor for the converted first input parameter by using the vector instruction set, to obtain noise simulation results respectively corresponding to the plurality of groups of random numbers.

7. The method according to claim 3, wherein the primitive function is configured to generate a circuit structure of a target quantum circuit according to a group of control parameters in the quantum circuit simulation, and the performing the vector parallelism on the second tensor for the converted first input parameter comprises:
splicing a plurality of groups of control parameters into the second tensor for the converted first input parameter; and
performing the vector parallelism on the second tensor for the converted first input parameter by using the vector instruction set, to obtain circuit structure generation results respectively corresponding to the plurality of groups of control parameters.

8. The method according to claim 3, wherein the primitive function is configured to perform a circuit measurement of a target quantum circuit according to a group of measurement parameters in the quantum circuit simulation, and the performing the vector parallelism on the second tensor for the converted first input parameter comprises:
splicing a plurality of groups of measurement parameters into the second tensor for the converted first input parameter; and
performing the vector parallelism on the second tensor for the converted first input parameter by using the vector instruction set, to obtain measurement results respectively corresponding to the plurality of groups of measurement parameters.

9. The method according to claim 1, wherein the converting the primitive function to the target function comprises:
modifying the first input parameter in the primitive function to the converted first input parameter; and
in response to a second input parameter in the primitive function of no parallelizing need, retaining the second input parameter in the target function.

10. The method according to claim 1, wherein the converting the primitive function to the target function comprises:
calling a function conversion interface with the primitive function and first information being provided to the function conversion interface, the first information indicating the first input parameter in the primitive function for parallelizing, and the function conversion interface causing the primitive function to be converted to the target function according to the first information.

11. The method according to claim 10, further comprising:
providing second information to the function conversion interface, the second information indicating a second input parameter in the primitive function for calculating a derivative, the function conversion interface converting the primitive function to the target function according to the first information and the second information, and the target function comprising derivative information of the primitive function according to the second input parameter.

12. The method according to claim 11, wherein the function conversion interface comprises a first interface and a second interface,
the first interface is configured to convert the primitive function to a first target function according to the first information; and
the second interface is configured to convert the primitive function to a second target function according to the first information and the second information.

13. The method according to claim 10, wherein the function conversion interface is an application programming interface (API) that encapsulates a machine learning library, the machine learning library is configured to provide a vector instruction set for executing the target function to obtain the execution result.

14. An apparatus for a quantum circuit simulation, comprising processing circuitry configured to:
receive a primitive function for the quantum circuit simulation;
determine at least a first input parameter of the primitive function, the quantum circuit simulation including a plurality of first tensors respectively for the first input parameter;
convert the primitive function to a target function according to the primitive function and at least the first input parameter, the target function including a converted first input parameter corresponding to the first input parameter, the plurality of first tensors being spliced into a second tensor for the converted first input parameter in the quantum circuit simulation;
obtain an execution result of the target function according to at least the second tensor for the converted first input parameter; and
perform the quantum circuit simulation based on the execution result of the target function.

15. The apparatus according to claim 14, wherein the processing circuitry is configured to:
process the converted first input parameter through a vector parallelism to obtain the execution result.

16. The apparatus according to claim 15, wherein the processing circuitry is configured to:
perform the vector parallelism on the second tensor for the converted first input parameter by using a vector instruction set, the vector instruction set comprising one or more executable instructions to be executed by the processing circuitry to perform the vector parallelism on the second tensor for the converted first input parameter.

17. The apparatus according to claim 16, wherein the primitive function is configured to process an input wave function of a target quantum circuit in the quantum circuit simulation, and the processing circuitry is configured to:
splice a plurality of input wave functions of the target quantum circuit into the second tensor for the converted first input parameter; and
perform the vector parallelism on the second tensor for the converted first input parameter by using the vector instruction set, to obtain processing results respectively corresponding to the plurality of input wave functions.

18. The apparatus according to claim 16, wherein the primitive function is configured to optimize a group of circuit variation parameters of a target quantum circuit in the quantum circuit simulation, and the processing circuitry is configured to:
splice a plurality of groups of circuit variation parameters of the target quantum circuit into the second tensor for the converted first input parameter; and
perform the vector parallelism on the second tensor for the converted first input parameter by using the vector instruction set, to obtain optimization results respectively corresponding to the plurality of groups of circuit variation parameters.

19. The apparatus according to claim 16, wherein the primitive function is configured to generate circuit noise of a target quantum circuit in the quantum circuit simulation according to a group of random numbers, the processing circuitry is configured to:
splice a plurality of groups of random numbers into the second tensor for the converted first input parameter; and
perform the vector parallelism on the second tensor for the converted first input parameter by using the vector instruction set, to obtain noise simulation results respectively corresponding to the plurality of groups of random numbers.

20. A non-transitory computer-readable storage medium storing instructions which when executed by at least one processor cause the at least one processor to perform:
receiving a primitive function for the quantum circuit simulation;
determining at least a first input parameter of the primitive function, the quantum circuit simulation including a plurality of first tensors respectively for the first input parameter;
converting the primitive function to a target function according to the primitive function and at least the first input parameter, the target function including a converted first input parameter corresponding to the first input parameter, the plurality of first tensors being spliced into a second tensor for the converted first input parameter in the quantum circuit simulation;
obtaining an execution result of the target function according to at least the second tensor for the converted first input parameter; and
performing the quantum circuit simulation based on the execution result of the target function.
